(19) United States
(12) Patent Application Publication
(10) Pub. No.: US 2009/0256695 A1
(43) Pub. Date: Oct. 15, 2009

(54) Method for the Automatic Initialization of Electronic Wheel Systems and Vehicle

(75) Inventors: Jurgen Bettecken, Regensburg (DE); Frank Fischer, Regensburg (DE)

Correspondence Address: LERNER GREENBERG STEMER LLP, P O BOX 2480, HOLLYWOOD, FL, 33022-2480, US

(73) Assignee: CONTINENTAL AUTOMOTIVE GMBH, Hannover (DE)

(21) Appl. No.: 12/420,843

(22) Filed: Apr. 9, 2009

(30) Foreign Application Priority Data
Apr. 9, 2008 (DE) 10 2008 018 014.9

(51) Int. Cl. B60C 23/02

(52) U.S. Cl. 340/442

(57) ABSTRACT

A method for the automatic initialization of the electronic wheel systems of a tire pressure checking system, performs the now described steps. Record signals are sent by electronic wheel systems. The received signals are evaluated on the basis of their signal strength by using criteria, which are obtained in at least one of the now described substeps. The signal strength in question of the received signals is average, the signal strength in question of the received signals is compared with a predefined threshold value, and the minimum and/or the maximum values of the signal strength of the received signals are calculated. The electronic wheel systems allocated to the tire pressure checking system are selected on the basis of the criteria obtained in the above-mentioned steps. The selected electronic wheel systems are automatically initializated.

### CROSS-REFERENCE TO RELATED APPLICATION

This application claims the priority, under 35 U.S.C. § 119, of German application DE 10 2008 018 014.9, filed Apr. 9, 2008; the prior application is herewith incorporated by reference in its entirety.

### BACKGROUND OF THE INVENTION

### Field of the Invention

The invention relates to a method for the automatic initialization of electronic wheel systems of a tire pressure checking system and a vehicle.

The present invention lies within the scope of systems for the indication or the determination of tire-specific parameters. In general, such systems are referred to as tire information systems, tire checking systems or tire pressure checking systems.

Because the safety and the reliability of the vehicle are central factors in the automotive industry, for safety reasons alone the tire pressure of motor vehicles has to be checked at regular intervals. Because the checking is very often neglected, modern motor vehicles increasingly have tire pressure checking systems, which measure the tire pressure automatically and should detect a critical deviation of the measured tire pressure from a set value of the tire pressure at an early stage.

A tire pressure checking system has at least one electronic wheel system for each wheel, which is for example fitted in the area of the wheel rim and which includes a sensor in order to record tire-specific parameters of the specific wheel and to transmit information derived from this measured value of the parameter. The electronic wheel system is equipped with a transmitting antenna by which the recorded information can be transmitted to a receiving device on the vehicle side. On the vehicle side, the tire pressure checking system has at least one receiving device, which records the wheel signals sent by the electronic wheel system and forwards them to a central computer unit of the vehicle for further evaluation.

A function of modern tire pressure checking systems is the so-called automatic initialization. In the case of automatic initialization, those tires having electronic wheel systems are newly broken in and for this reason are directly assigned to the vehicle or to the associated tire pressure checking system. In the case of the automatic initialization and the initiating of the electronic wheel system, the signals sent by these electronic wheel systems and if necessary their signatures are evaluated to carry out on the basis of the evaluation, a fully automatic unambiguous assignment of the electronic wheel system to the vehicle. In this process, the assigning can in addition be carried out in such a way that also the exact position of the specific wheel referred to the vehicle is determined.

In published, non-prosecuted German patent application DE 10 2006 032 212 A1, corresponding to U.S. patent publication No. 2008/027669, such a method for indicating the tire pressure is described, which contains an automatic initialization.

The automatic initialization can be carried out when the vehicle is stationary or also while it is being driven. It is problematic during the automatic initialization while the vehicle is stationary that in these cases, signals sent by the electronic wheel systems cannot be recorded from time to time on the vehicle side because these electronic wheel systems are for example in a transmission gap of the vehicle. For these reasons, automatic initialization while the vehicle is being driven is preferred. Though, in addition to the transmission signals sent by the individual electronic wheel systems of the vehicle, transmission signals from other electronic wheel systems are also recorded from time to time. Such undesirable signals originate for example from passing vehicles that have also been fitted with a corresponding tire pressure checking system. In order to eliminate the influence of the electronic wheel systems of other vehicles, provision can be made for simple filter measures.

In particular in coupling systems of a vehicle containing a trailer such as for example a truck (LKW) with a trailer or a semitrailer, an independent tire pressure checking system can in each case be fitted both in the tractor and in the trailer. The problem of this is that both the electronic wheel systems on the tractor and the trailer show similar signal characteristics and contents so that an unambiguous allocation of the electronic wheel system belonging to the tractor or to the trailer is exceptionally difficult and impossible from time to time. In particular, in the case of this form of automatic initialization it is for example possible not to use the speed, the direction of travel and the like as criteria for the assigning of an electronic wheel system because these criteria are almost identical for the electronic wheel system of the tractor and the trailer. In the case of such coupling systems of a vehicle containing a trailer, automatic initialization is not reliable while the vehicle is being driven.

However, one possibility of initializing the electronic wheel systems now consists of manually programming the control unit of the tire pressure checking system in such a way that an unambiguous assigning of the respective electronic tire systems is provided. In order to be able to carry out the initialization, the vehicle on the one hand must be stationary and, on the other hand, preferrably connected to a so-called initialization tool, which mostly requires a visit to the workshop. For this reason, in addition to the corresponding workshop costs, the vehicle also has to be off the road, which is in particular aggravating in the case of trucks, which should be off the road for the shortest possible time.

### SUMMARY OF THE INVENTION

It is accordingly an object of the invention to provide a method for the automatic initialization of electronic wheel systems and a vehicle which overcome the above-mentioned disadvantages of the prior art methods and devices of this general type, which provides an improved automatic initialization of the electronic wheel systems of a vehicle.

Accordingly provision is made for a method for the automatic initialization of electronic wheel systems of a tire pressure checking system. The method includes the steps of:

(a) recording the signals which were sent by the electronic wheel systems;
(b) evaluating the received signals on the basis of their signal strength with reference to criteria which are obtained by at least one of the following substeps: (b1) averaging the signal strength of the received signals in question; (b2) comparing the signal strength of the received signals with a predefined threshold value; (b3) and calculating minimum and/or maximum values of the signal strength of the received signals;
(c) selecting the electronic wheel systems assigned to the tire pressure checking system on the basis of the criteria obtained in steps (b1)-(b3); and
(d) automatically initializing the selected electronic wheel systems.

A computer program product, which defines an algorithm, can perform the above-identified method.

A vehicle, in particular a tractor and/or a trailer of a truck with a plurality of wheels of the vehicle, has a tire pressure checking system. The tire pressure checking system has a plurality of the electronic wheel systems assigned to the individual wheels of the vehicle and which in addition has an initialization device, which is embodied in such a way that it carries out an automatic initialization of the electronic wheel systems by the method in accordance with the invention.

In essence, the method in accordance with the invention is based on the evaluation of the signals originating from the different electronic wheel systems, which are evaluated on the basis of their signal strengths in a different manner. The idea of the present invention is that received signals, which originate from its own, that is from electronic wheel systems of the tire pressure checking system, at least typically have a higher signal strength over a longer period in time than received signals from foreign electronic wheel systems. This in particular relates to vehicles with a trailer because in this case the electronic wheel systems are for example fitted in the tractor, while the foreign electronic wheel systems are fitted in the trailer. If one assumes that all the electronic wheel systems transmit at the same signal strength, then a receiving device of the tire pressure checking system receives the different sent signals of the tractor and the trailer with different signal strengths each time, with the signals transmitted from the foreign electronic wheel systems, after they have been received, exhibiting a lower signal strength. Using a timing average of these received signal strengths, by determining the maximum and the minimum values of the received signal strengths and/or by comparing the received signal strengths with a predefined threshold value, which is for example based on empirically obtained values, in this case an unambiguous and reliable assigning of the received signals to the different electronic wheel systems can be made. Automatic initialization can be brought about after that.

The idea underlying the present invention consists of making provision for an automatic initialization of the electronic wheel systems of the tires of a tire pressure checking system, in the case of which a number of criteria are used in order to be able to distinguish between the electronic wheel systems assigned to a tire pressure checking system and the electronic systems of tires of other tire pressure checking systems. When determining these criteria, the received signals which originate from random electronic wheel systems are evaluated, with a different method being used for the evaluation in accordance with the invention. Each and every one of these methods would already be suitable to make a more or less reliable allocation of the electronic wheel system to the tire pressure checking system. However, this allocation is made difficult in the case of the application of this automatic initialization while the motor vehicle is being driven, in the case of which in accordance with experience, interference effects that prevail to a greater or lesser degree, for example also the signals of the electronic wheel systems of other tire pressure checking systems are received. An unambiguous distinguishability and thereby an unambiguous allocation of the individual electronic wheel systems to the electronic wheel systems of other tire pressure checking systems, is then made difficult from the signals received in the situations that have just been described, when merely one of the mentioned methods is used. While, depending on the situation and the application, one method or also a number of the different methods is used, provision can be made for a very reliable method for the automatic initialization of the electronic wheel systems, which also operates in a reliable manner under tough, difficult operational conditions. Such tough, complicated conditions are for example automatic initialization while the vehicle is being driven, for example in the case of a driving on a freeway.

Particularly, advantageous is the method in accordance with the invention provided that a coupling system of a vehicle containing a trailer is used, which has more than two tire pressure checking systems operating independently from each other. By the method in accordance with the invention, an unambiguous allocation of these electronic wheel systems can be undertaken on the basis of the signal strength of the different received signals, which can originate from individual or also from the foreign electronic wheel systems and subsequently a very reliable automatic initialization of these electronic wheel systems can be carried out.

In a preferred development, the predefined threshold values are adapted dynamically. In this case, the dynamic adaptation is undertaken on the basis of the signal strength averaged in the procedural step (b1). It can in particular occur that the electronic systems for the tires transmit over time at a lower signal strength, which is for example caused by the voltage drop of the battery. The averaging of the signal strengths of the received signals in procedural step (b1) allows this slow decrease in the signal strength of an electronic wheel system to be perceived and it can be incorporated into procedural step (b2) for determining the threshold value used there.

In a preferred embodiment, in step (c) those electronic wheel systems are selected which in step (b1) exhibit the highest averaged signal strength. In addition or as an alternative, provision can also be made for the electronic wheel systems to be selected which in step (b2) lie above the predefined threshold value in each case. In addition or as an alternative provision can also be made for those electronic wheel systems to be selected, which in step (b3) have the highest maximum signal strength values. As an alternative to the aforementioned procedure, those electronic wheel systems can also be rejected to which the lowest minimum signal strength values have been assigned. Each one of the methods just mentioned makes a proposal per se for selection of an electronic wheel system for the automatic initialization, with the combination of these different methods creating a better distinguishability of the electronic wheel systems allocated to the tire pressure checking system and thereby increasing the reliability.

In a preferred embodiment, for each step (b1)-(b3), based on the values determined there, in a descending sequence of the determined values, a series is determined for the corresponding electronic wheel systems allocated to the receiving signals. In this case, it is assumed that the highest values in each case determined in steps (b1)-(b3) tend to be allocated to the tire pressure checking system and the lower values tend to be allocated to the foreign electronic wheel systems. In so far as the different methods are combined with one another, the expressiveness can be increased and with correspondingly higher probability it can be decided on an individual electronic wheel system that is allocated to the tire pressure checking system and thus be distinguished from foreign electronic wheel systems.

In the event of tire pressure checking system having different electronic wheel systems, a maximum N electronic wheel systems are used for automatic initialization in accordance with a particularly preferred embodiment of the present invention. In particular, in the event of not all of the N electronic wheel systems being able to be allocated in an unambiguous manner, fewer than the N electronic wheel systems of the tire pressure checking system can also be initialized automatically. The remaining, i.e. the non-automatically initialized electronic wheel systems, can then at a later point in time, as required, also be initialized manually or sometimes even not at all.

In accordance with a particularly preferred embodiment, an electronic wheel system is then selected, provided that it complies with at least two and especially advantageously with at least three of the above-mentioned criteria within the N highest rated electronic wheel systems in each case. This classification of the electronic wheel systems is undertaken on the basis of the measured and the evaluated signal strengths of the received signals concerned. This development is based on the knowledge that provided that an electronic wheel system complies with at least two and especially three or more criteria within the N highest-rated electronic wheel systems, it can be concluded here with a very high probability that this electronic wheel system involves a foreign electronic wheel system in each case.

In accordance with a preferred embodiment the method in accordance with the invention contains the further following steps: providing the N+1 highest values for at least one criterion; determining a difference between the N highest values in each case and the lowest value of the N+1 highest values for this criterion; specifying a minimum difference in this criterion, with those values of this criterion for which the determined difference lies within the predefined minimum difference remain unconsidered for the automatic initialization. Therefore, in this case virtually a minimum distance in terms of value, between the highest N values and the highest value, that is allocated presumably to a foreign electronic wheel system, is calculated. If this minimum distance is very small, if possible an unambiguous distinction between own and foreign electronic wheel system can no longer be made so that then in these cases such measured values of the received signal are no longer used for the distinction and the selection of the different electronic wheel systems. This minimum distance is typically predefined on the basis of empirical values or also by testing. In this case, it is assumed that the first N values of the received signals of the individual electronic wheel systems to the N+I value of the received signals on the basis of the greater distance of the foreign electronic wheel systems is sufficiently great. If this is not the case, there would be a danger of a foreign electronic wheel system being weighted as an individual electronic wheel system in an incorrect manner and automatically initialized. In order to avoid such a wrong decision, in such cases unlike in the otherwise predefined method of approach, only those N electronic wheel systems are considered of which the allocated signal values have a sufficiently large distance referred to the next lower value.

In accordance with a particularly preferred embodiment, each criterion is weighted with a weighting factor. In this way it is possible to evaluate differently the different criteria which are based on a different evaluation method. This is especially advantageous if, for example, one criterion or a plurality of criteria has a higher reliability factor than that of other criteria based on values obtained empirically, investigations and the like. In this case, the more reliable criteria can for example be weighted higher. The weighting can for example be based on information about the relevance, authenticity, vehicle application, measuring accuracy of the criterion and the like. However, other evaluation criteria such as for example values obtained empirically would of course also be feasible.

In another preferred embodiment, the method in accordance with the invention step (b) only begins when a signal allocated to an electronic wheel system in step (a) is received for a predefined minimum duration. In this way, it is for example possible that too short an influence of a received signal, in the same way as for example occurs by a vehicle driving past, can be avoided.

In a further development, the predefined minimum duration is extended, provided that the tire pressure checking system is fitted into an arrangement of the vehicle which has a number of tire pressure checking systems operating independently from each other in the same way as this is for example the case in a coupling system of a vehicle containing a trailer. In this case, simply because of the larger number of available electronic wheel systems resulting from this arrangement, a larger number of transmission signals also have to be processed and evaluated by these electronic wheel systems, which is sometimes no longer possible within the predefined minimum duration. By extending the minimum duration, this is taken into account and it is ensured in particular that for the phase in which the transmission signals are recorded, sufficient time is available for the recording of signals and their evaluation and that too short a predefined minimum duration is not taken as a starting criterion for this.

In a preferred embodiment, in the event of automatic initialization, information about the speed of the vehicle is included as a further criterion, which for example, shows the driving condition of the vehicle. In this way, it can be ensured that the automatic initialization always takes place while the vehicle is being driven and not in a stationary or in a parking mode. As a result of the fact that the automatic initialization always takes place while the vehicle is being driven it can also be ensured that signals are received from all the electronic wheel systems of the tire pressure checking system. A dead transmission angle and/or a receiving angle is effectively prevented here.

In a particularly preferred embodiment a check is carried out, in the inventive method in order to determine whether or not an electronic wheel system allocated to a transmitted signal has already been initialized. In this case, it is not initialized again. In the case of this electronic wheel system it is instead assumed that it already belongs to the tire pressure checking system and has already also passed through a learning process in accordance with automatic initialization.

In a preferred development of the vehicle in accordance with the invention, the electronic wheel system has a sensor and in particular a pressure sensor for determining tire-specific parameters. These tire-specific parameters can for example be the tire pressure, the tire temperature, the profile thickness, the angular speed of the wheel, the wheel acceleration and the like.

In a particularly preferred embodiment of the vehicle in accordance with the invention, this is embodied as a coupling system of a vehicle containing a tractor and a trailer, for example as a truck-trailer combination or as a truck with a trailer, in the case of which both the tractor and the trailer in each case have an individual tire pressure checking system operating independently from each other with different electronic wheel systems. However, the invention could of course also be used to advantage in the case of other vehicles with tire pressure checking system operating independently from each other.

Other features which are considered as characteristic for the invention are set forth in the appended claims.

Although the invention is illustrated and described herein as embodied in a method for the automatic initialization of electronic wheel systems and a vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### DETAILED DESCRIPTION OF THE SEVERAL VIEWS OF THE DRAWING

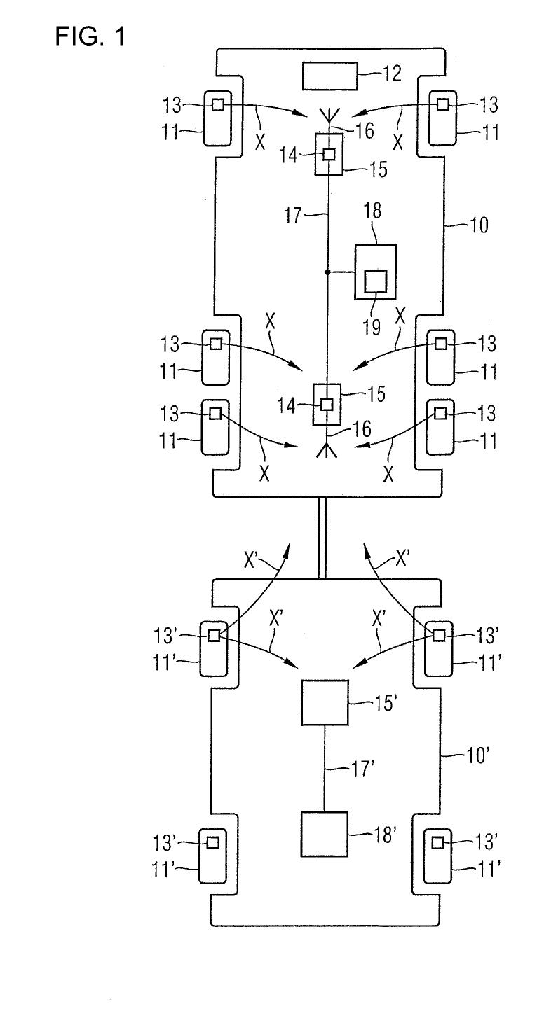

FIG. 1 is a schematic overhead view of a truck with a trailer to illustrate an exemplary embodiment of a tire pressure system in accordance with the invention;

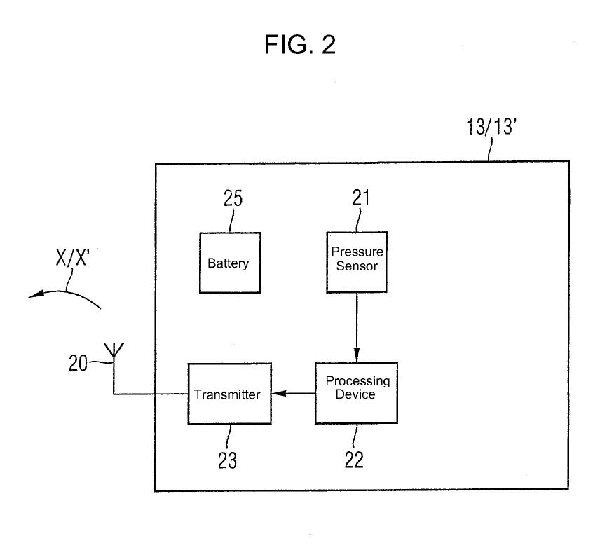

FIG. 2 is a block diagram of an exemplary assembly of an electronic wheel system of a tire pressure system in accordance with the invention; and

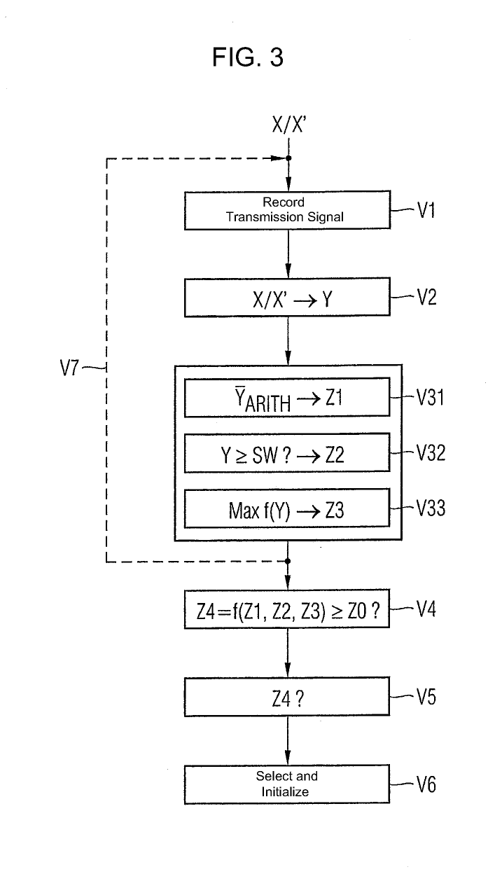

FIG. 3 is a flow diagram illustrating the method in accordance with the invention.

### DETAILED DESCRIPTION OF THE INVENTION

In the figures in the drawings, unless stated otherwise, the same or functionally similar elements, features and signals are labeled with the same reference symbols. Referring now to the figures of the drawing in detail and first, particularly, to FIG. 1 thereof, there is shown a greatly simplified schematic diagram of a vehicle to illustrate an exemplary embodiment of a tire pressure system in accordance with the invention. In FIG. 1, the reference symbol 10 refers to the vehicle, for example a truck (LKW).

In this case, the vehicle 10 has only for example N=6 wheels 11. The vehicle 10 in addition has a tire pressure checking system in accordance with the invention which has electronic wheel devices 13 on the wheel side also referred to as electronic wheel systems 13 below. The tire pressure checking system further has receiving devices 14, 15, 16, a bus 17 as well as a control unit 18 on the vehicle side. An electronic wheel system 13 is allocated to each individual wheel 11. The electronic wheel system 13 is arranged in a known manner in the area of the valve or the rim of the wheel 11 in question.

In addition, a trailer 10′ is coupled to the vehicle 10 embodied as a truck. It is likewise assumed that the trailer 10′ also has its own individual tire pressure checking system, which operates independently of the tire pressure checking system of the vehicle 10. For this purpose, wheels 11′ of the trailer 10′ are fitted in a similar manner according to the electronic wheel systems 13′. In addition, the trailer 10′ has a receiving device 15′, which is connected by a bus 17′ to a control unit 18′.

FIG. 2 is a block diagram to show a schematic layout of such an electronic wheel system 13, 13′. In the present exemplary embodiment the electronic wheel system 13, 13′ has a pressure sensor 21, a processing device 22 connected to the pressure sensor 21 and a transmitter 23 connected to the processing device 22. These elements 21-23 are in each case supplied with electric energy by a local energy supply 25, for example an accumulator or a battery. To this end, the wheel sensor 21 is configured in such a way as to determine wheel-specific parameters, such as for example the tire pressure. The processing device 22 of the electronic wheel system 13 carries out a preliminary evaluation of the information obtained from the wheel sensor 21. The information determined by the electronic wheel system 13, 13′, is modulated or coded into a transmission signal X, X′, which is transmitted via a wireless communication connection to the vehicle 10. For this purpose, each electronic wheel system 13, 13′ contains a transmitting antenna 20 as a component of the transmitter 23.

In order to receive the transmitted transmission signals X, X′, the tire pressure checking system of the truck 10 on the vehicle side at least has one and in the present case, two receiving devices 15. The receiving device 15, is supplied with electric energy by an energy source 12 of the truck 10, for example the battery of the vehicle, in a manner not shown and in each case has a receiving antenna 16 and a receiving stage 14 connected to a receiving antenna 16.

In addition, the tire pressure checking system on the vehicle side has a microprocessor 19 as an example of a central control device and an evaluation device. The microprocessor 19 and, if required, also the receiving phase 14 with the receiving antenna 16 are components of the control units 18 for indicating the tire pressure. The control unit 18, the receiving devices 15 and the electronic wheel system 13 are provided for measuring the individual tire pressures of the different wheels 11, evaluating the measured tire pressures and notifying a person not shown in more detail driving the truck 10, optically or acoustically when one of the tires has a tire pressure that is too low for example.

In addition, the tire pressure checking system contains the bus 17, for example a single wire or a double wire CAN bus (CAN=Controller Area Network) or a LIN bus (LIN=Local Interconnect Network), to which the receiving device 15 and the control unit 18 are connected via the respective connection lines.

In addition, the tire pressure checking system of the truck 10, in accordance with the invention, has a device for the automatic initialization of the electronic wheel systems 13 allocated to the tire pressure checking system of the truck 10. This functionality of the device for the automatic initialization is implemented, inter alia, in each electronic wheel system 13 in coordination with the central control device and the evaluation device 19.

The functionality of the device for automatic initialization in accordance with the invention is shown by the sequence diagrams in FIG. 3 and is now explained.

In a first step V1, a transmission signal X, X′ transmitted by an electronic wheel system 13, 13′ is recorded.

The signal strength Y is subsequently determined from the recorded transmission signal X (step V2).

The signal strength y of the recorded transmission signals x is evaluated in subsequent step V3. Criteria Z1-Z3 are determined within the scope of the evaluation of the signal strength Y, on the basis of which in subsequent steps V4 and V5, an automatic initialization of the electronic wheel system transmitted by the transmission signal X takes place (or also not). This evaluation takes place in the substeps V31-V33.

The signal strength Y is averaged in the substep V31 by calculating for example the arithmetic mean value Y̅_{ARITH} of the signal strength Y.

From the arithmetic mean value Y̅_{ARITH}, a first value Y1 is determined, which can be used as a first criteria for the subsequent selection of the electronic wheel system.

In a substep V32, the signal strength Y of the received transmission signals X, X′ is compared to a predefined threshold value SW. Depending on this comparison, a second value Y2 is determined, which represents a second criterion for the selection.

In a third substep V33, the maximum value of the signal strength Max_{f(y)} is determined. However, it would also be feasible as an alternative to determine the minimum values of the signal strength Min_{f(y)}. A third value Y3 which forms a third criterion is generated from these maximum values max(y).

The values Y1, Y2, Y3 determined in the procedural step V3 are processed in a subsequent procedural step V4 in order to be able to make a selection so as to decide in the subsequent procedural step V5, whether or not provision has been made for the electronic wheel system 13, 13′ transmitting the transmission signal x, x′ for the automatic initialization. In the simplest case, this processing can be such that the values Z1, Z2, Z3 are added to one another and a resulting value Z4 is determined. The value Z4, which thus contains all three of the criteria Z1 to Z3 is then compared to a comparative value Z0. If the determined value Z4 for example is above that of the comparative value Z0 (thus Z4≧Z0), it can then for example be concluded as a result that the electronic wheel system transmitting the transmission signal is an individual electronic wheel system. In this case, in a next step V5 this electronic wheel system would have been selected and automatically initialized in a subsequent step V6. As an alternative, it would also be feasible in a procedural step V4 that only one of the criteria Z1 to Z3 or even two of the criteria Z1 to Z3 are used for determining the value Z4. Over and above that, it would be feasible to use also further criteria such as for example information about the speed in order to determine the value Z4.

In procedural step V4, which represents the individual values Z1 to Z3, the criteria for the automatic initialization are preferrably multiplied by a weighting factor. The weighting factor takes into account the situation, which should have the reliability of the different values Z1 to Z3. In addition, the weighting factors can also contain information about the measuring accuracy.

In a particularly preferred embodiment provision has been made that in accordance with the procedural step V4, the method reverts to the procedural step V1 (step V7), by recording further transmission signals X, X′, in particular transmission signals X, X′ from other electronic wheel systems. The transmission signals X, X′ from other electronic wheel systems can then in a corresponding manner pass through the procedural steps V1 to V4, by evaluating in the procedural step V3 their signal strength Y and in a procedural step V4 the criteria values Z1 to Z3 derived from this are determined. This can take place until all the individual electronic wheel systems 13 of the individual tire pressure indicating system have preferrably been recorded in accordance with the transmission signals X. Because this takes a certain period of time into account, during this time typically also signals X′ of other electronic wheel systems 13′, that is signals X′ are recorded, which are allocated to an electronic wheel system 13′ of another tire pressure checking system in a typical manner. As soon as all the recorded signals X, X′ have been collected, evaluated and processed, the selection of the electronic wheel systems 13 of the individual tire pressure checking system can be carried out subsequently in a procedural step V5. This can, as already mentioned, on the basis of a comparison with a predefined example also take place by a dynamically adjustable threshold value Z0. Provided that the individual tire pressure checking system has a number of N electronic systems of a tire, it would also be feasible to select the N electronic wheel systems in a step V5, which in each case in a step V4 have the N highest values Z4. In this case, it can be assumed with the highest probability that these N values Z4 must be allocated to the individual electronic wheel systems 13.

In order to increase the safety further, provision can in addition be made that all the N electronic wheel systems, for which the N highest values Z4 are determined in the step V4, show a sufficiently large minimum distance from the next higher N+I electronic wheel system. In this way it can be ensured in an even better manner that a foreign electronic wheel system 13′ is not allocated by accident to its own individual tire pressure checking system.

Although the present invention was explained above by a preferred exemplary embodiment in greater detail, it is not limited to that, but can be modified in numerous different ways.

In the exemplary embodiment shown above in FIGS. 1-3 it was assumed that the tire pressure checking system was implemented in the tractor and for this reason in the truck 10 and should be learnt by the automatic initialization of their electronic systems of tires. It would of course also be feasible that the trailer has the same or a similar tire pressure checking system, which operates in the same way or more or less modified.

The invention is suitable for any vehicles such as for example in the case of busses, truck-trailer combinations, truck-trailers, passenger motor vehicles and the like.

In addition, the tire checking systems described above refer to concrete devices in a vehicle.

In addition, in the above-mentioned exemplary embodiments it would be assumed that for the automatic initialization three criteria would be used on the basis of the signal strength. However, also feasible would be to use less than three or more than three criteria for the signal strength. Although the signal strength is particularly preferred, it would also be feasible to use another parameter instead of the signal strength or in a combination with the signal strength for the determination of the different criteria.

1. A method for automatic initialization of electronic wheel systems of a tire pressure checking system, which comprises the steps of:
a) recording signals transmitted by the electronic wheel systems;
b) evaluating the signals received on a basis of signal strength by means of criteria, which are obtained by means of one of the following substeps:
b1) averaging the signal strength of the signals received in question resulting in averaged signal strength values;
b2) comparing a relevant signal strength of the signals received with a predefined threshold value;
b3) calculating at least one of minimum values and maximum values of the signal strength of the signals received;
c) selecting the electronic wheel systems allocated to the tire pressure checking system on a basis of the criteria obtained in the steps bl)-b3)
d) automatically initializing selected electronic wheel systems.

2. The method according to claim 1, which further comprises adjusting the predefined threshold value dynamically on a basis of the averaged signal strength values adjusted in the step b1).

3. The method according to claim 1, which further comprises in step c), selecting the electronic wheel systems on a basis of at least one of:
the highest averaged signal strengths derived in step b1);
assigned signals lying above the predefined threshold value in step b2); and
the exhibited highest maximum values of the signal strength in step b3).

4. The method according to claim 1, which further comprises forming a series of the electronic wheel systems allocated to the signals received, in descending order, based on the values determined in the steps b1)-b3).

5. The method according to claim 1, wherein the tire pressure checking system has N electronic wheel systems and a maximum of N of the electronic wheel systems is used for the automatic initialization in the step c).

6. The method according to claim 5, which further comprises selecting an electronic wheel system provided that the electronic wheel system has a minimum of two criteria lying within the N highest-rated electronic wheel systems.

7. The method according to claim 5, which further comprises:
providing a N+I highest value for at least one criterion;
determining in each case a difference between the N highest values and the lowest value of the N+1 highest values for the criterion;
specifying a minimum difference for the criterion, with those values of the criterion for which a difference determined lies within a predefined minimum difference are not taken into consideration for automatic initialization.

8. The method according to claim 1, which further comprises weighting a value of each of the criterions with a weighting factor, the weighting factor includes at least one of information about a relevance of a criterion, an authenticity of the criterion, a vehicle application of the criterion and a measuring accuracy of the criterion

9. The method according to claim 1, which further comprises beginning step b) only when the signal allocated to an electronic wheel system in step a) is received for a predefined minimum duration.

10. The method according to claim 9, which further comprises extending the predefined minimum duration for a case in which the tire pressure checking system is fitted in a vehicle that features a number of independent tire pressure checking systems.

11. The method according to claim 1, which further comprises taking into account information about a speed of the vehicle as a further criterion and that only such received signals are used for the automatic initialization that indicate a driving condition of the vehicle.

12. The method according to claim 1, which further comprises performing a check to determine whether or not an electronic wheel system allocated to the signal received has already been initialized and that in this case a new initialization of an already initialized electronic wheel system does not take place.

13. The method according to claim 6, which further comprises selecting the electronic wheel system provided that the electronic wheel system has a minimum of three criteria lying within the N highest-rated electronic wheel systems.

14. A computer readable medium having computer executable instructions for performing the method according to claim 1.

15. A vehicle, comprising:
a plurality of wheels;
a tire pressure checking system having a plurality of electronic wheel systems allocated to individual ones of said wheels and an initialization device configured such that an automatic initialization of said electronic wheel systems is performed, said initialization device programmed to:
record signals transmitted by said electronic wheel systems;
evaluate the signals received on a basis of signal strength by means of criteria, which are obtained by means of one of the following substeps:
b1) averaging the signal strength of the signals received in question resulting in averaged signal strength values;
b2) comparing a relevant signal strength of the signals received with a predefined threshold value;
b3) calculating at least one of minimum values and maximum values of the signal strength of the signals received;
select said electronic wheel systems allocated to said tire pressure checking system on a basis of the criteria obtained in the steps bl)-b3)
d) automatically initialize selected electronic wheel systems.

16. The vehicle according to claim 15, wherein each of said electronic wheel systems has a sensor for determining tire-specific parameters.

17. The vehicle according to claim 16, wherein said sensor is a pressure sensor.

18. The vehicle according to claim 15, wherein the vehicle is a coupling system and that both its tractor and its trailer has an independently operating tire pressure checking system allocated to the latter.

19. The vehicle according to claim 15, wherein the vehicle is selected from the group consisting of trucks, tractor machines, trailers for trucks, and tractor-trailers.
